(19) United States
(12) Patent Application Publication
(10) Pub. No.: US 2008/0283612 A1
(43) Pub. Date: Nov. 20, 2008

(54) SYSTEM AND METHOD FOR DETERMINING PRODUCT COUNTERFEITING AND DIVERSION

(75) Inventor: Richard A. Fearn, Cincinnati, OH (US)

Correspondence Address: THOMPSON HINE L.L.P.;Intellectual Property Group, P.O. BOX 8801, DAYTON, OH, 45401-8801, US

(73) Assignee: Spear USA, LLC, Mason, OH (US)

(21) Appl. No.: 11/748,250

(22) Filed: May 14, 2007

(51) Int. Cl. G06K 7/10; G06F 17/00; G06K 19/06

(52) U.S. Cl. 235/468; 235/375; 235/454; 235/494

(57) ABSTRACT

A method for use in determining product counterfeiting and diversion is provided. The method includes locating an overlay on a label associated with a product. The overlay delineates areas of the label, each area having an identifier associated therewith. Presence of a taggant is detected within one or more of the areas using a reader. The taggant is hidden from sight and provides an indication of its presence that is detectable by the reader.

### TECHNICAL FIELD

The present application relates to a system and method for determining product counterfeiting and diversion.

### BACKGROUND

It is frequently desirable to track and authenticate products as they travel along a supply line. Various product tracking and authentication systems are currently being developed. One such system utilizes RFID technology. In some proposed systems, a hand-held reader may be used to scan a RFID tag, which may then be used to identify and authenticate a grouping of inventory components, for example, that are being transported together on a pallet. It is desirable to provide other product tracking and authentication systems and methods.

### SUMMARY

In an aspect, a method for use in determining product counterfeiting and diversion is provided. The method includes locating an overlay on a label associated with a product. The overlay delineates areas of the label, each area having an identifier associated therewith. Presence of a taggant is detected within one or more of the areas using a reader. The taggant is hidden from sight and provides an indication of its presence that is detectable by the reader.

In another aspect, a system for use in determining product counterfeiting and diversion includes a label including a taggant located within a discrete region of the label. An overlay includes visual indicia that delineates areas of the label with the overlay placed thereon, each area having an identifier associated therewith. A reader detects presence of the taggant within a delineated area of the label.

Other advantages and features of the invention will be apparent from the following description of particular embodiments and from the claims.

### BRIEF DESCRIPTION OF DRAWINGS

FIGS. 1-3 illustrate various exemplary labels including a taggant at different locations;

FIG. 4 illustrates an embodiment of a label affixed to a container;

FIG. 5 is a detail view of the label of FIG. 4 in isolation;

FIG. 6 illustrates an embodiment of an overlay;

FIG. 7 illustrates the overlay of FIG. 6 positioned on the label of FIG. 4;

FIG. 8 illustrates an embodiment of a method of detecting the taggant with the label of FIG. 4;

FIG. 9 illustrates another method of detecting a taggant within a label; and

FIGS. 10 and 11 illustrate other overlay embodiments.

### DESCRIPTION

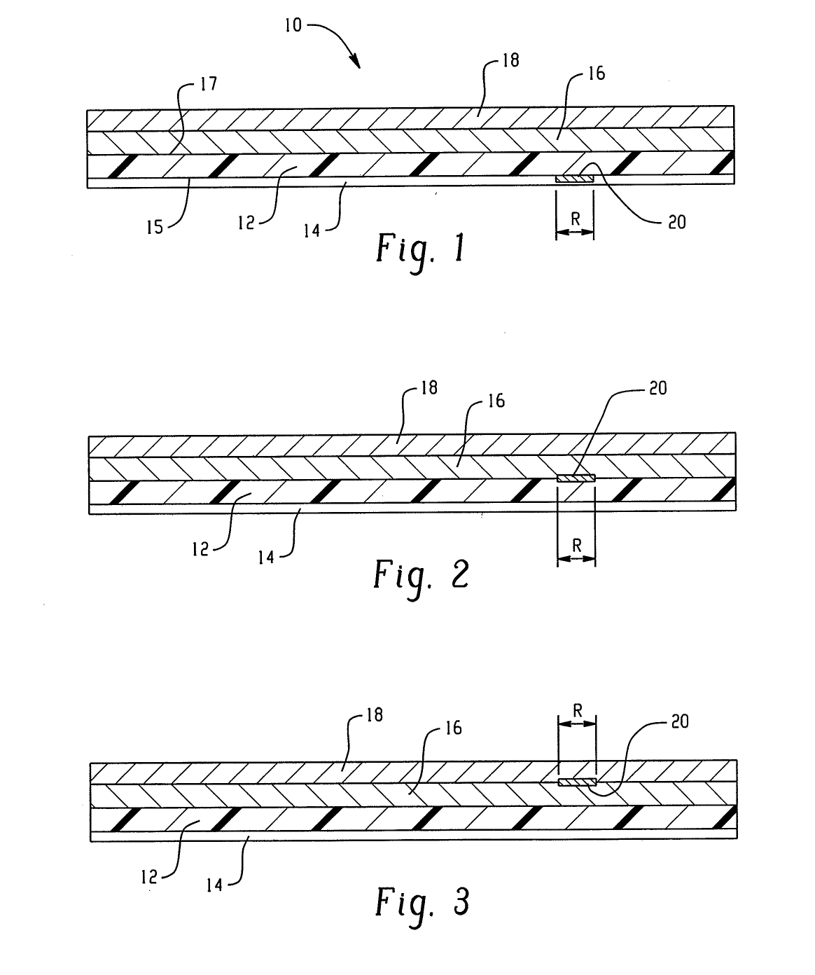

Referring to FIG. 1, a label 10 includes a facestock layer 12, which may be cut or otherwise formed into a discrete label shape, with an adhesive layer 14 located on a back 15 of the facestock layer and a primer layer 16 located on a face 17 of the facestock layer. In some embodiments, the facestock layer 12 is formed of polypropylene, but any other suitable material may be used such as paper, other polymeric materials such as polyethylene, PVC, cellophane, etc. In an exemplary embodiment, the facestock layer 12 is clear, however the facestock layer may be manufactured to have any color desired. For example, the facestock layer 12 may be manufactured to have an opaque, white color which gives the look of a paper label, while retaining the advantages of thin film labels. A print layer 18 is located on the primer layer 16. The print layer 18 may be created by applying ink to the primer layer 16 such as by screen printing, gravure printing, lithography, flexography or any other suitable method. The print layer 18 may also include hot stamped foil or embossed images (not shown). In an alternative embodiment, the print layer 18 may be applied directly to the facestock layer 12 without the primer layer 16.

A taggant 20 is provided with the label 10. As will be described in greater detail below, the taggant 20 (or lack thereof) is used to identify whether a product carrying the label 10 is counterfeit or has been diverted. As used herein, the term “product” encompasses individual products and a shipment of products, for example, collectively in a case. In many embodiments, the taggant 20 is not visible through the label 10. In FIG. 1, the taggant 20 is located under the print layer 18, primer layer 16 and facestock layer 12. In one embodiment, the taggant 20 is encapsulated within the adhesive layer 14. The print layer 18 is used to shield the taggant 20 from view.

As alternatives, FIG. 2 shows the taggant 20 between the facestock layer 12 and the primer layer 16. FIG. 3 illustrates the taggant 20 between the primer layer 16 and the print layer 18. Other configurations are contemplated. For example, the taggant 20 may be used with other label configurations such as those disclosed in U.S. Pat. Nos. 7,185,453, 7,090,907 and 6,818,271, the details of which are hereby incorporated by reference as if fully set forth herein.

The taggant 20 may be formed as a discrete region R of an emitting taggant material. As used herein, an “emitting taggant material,” refers to materials that emit radiation, for example, in the visible and/or infrared wavelengths by absorbing radiation from a radiation source. In some instances, the emitting taggant material may be in the form of a fine ceramic powder. The ceramic powder may be embedded within ink, adhesive, paper, plastic, fiber, film, etc. A suitable emitting taggant material is commercially available from Stardust Materials, L.L.C. of Vancouver, Wash. In another embodiment, the taggant 20 is formed using metal containing ink read by a magnetic reader.

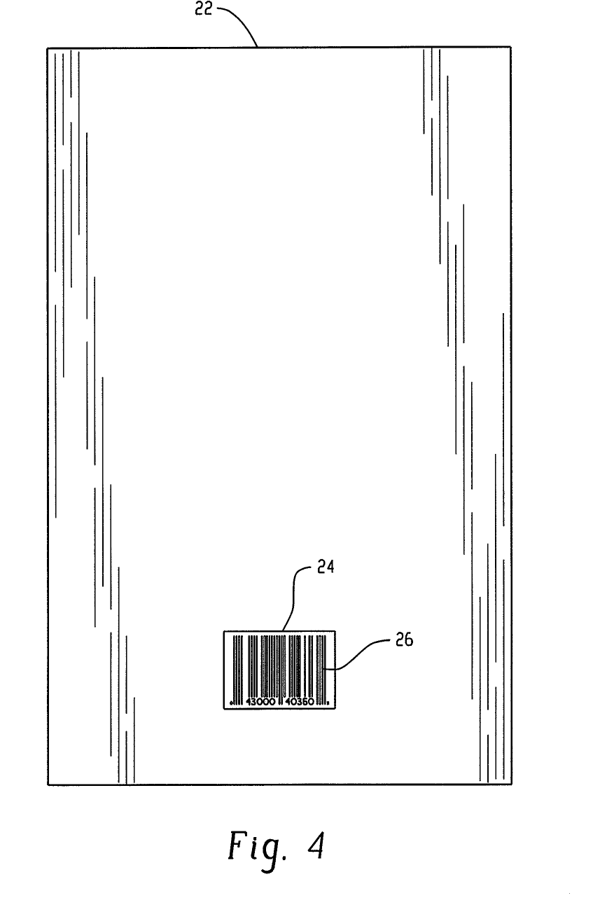

Referring to FIG. 4, a product container 22 includes a label 24 including the taggant 20, which is not visible through the label (i.e., the taggant is covert). The label 24 includes a barcode 26 printed thereon.

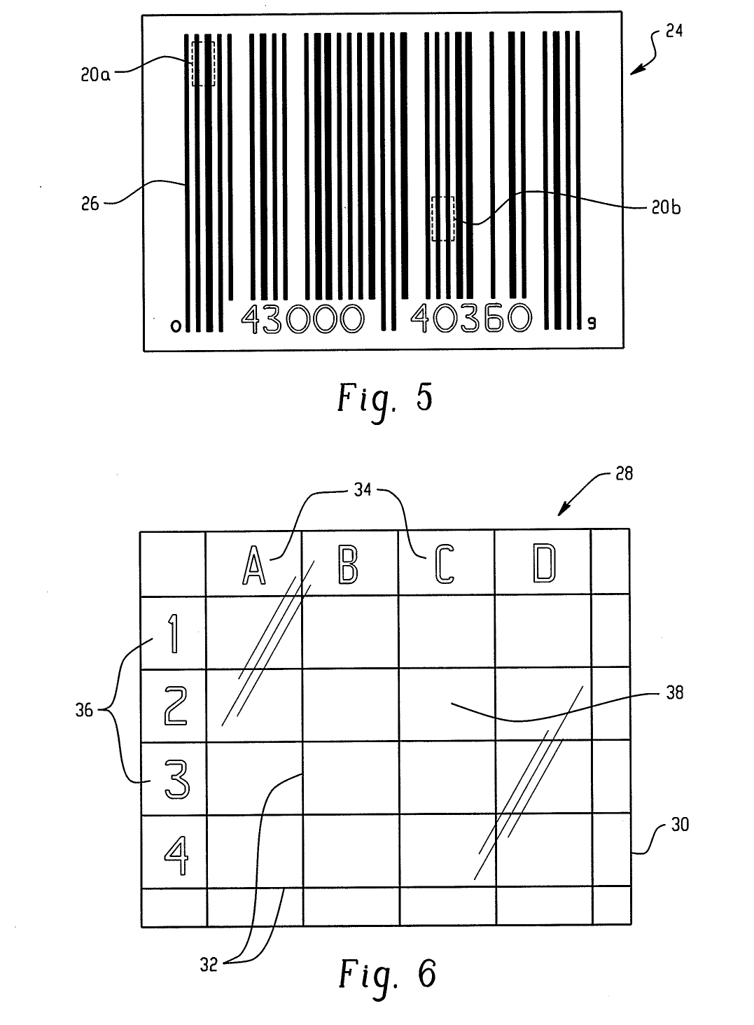

FIG. 5 shows the label 24 including barcode 26 in isolation. The label 24 includes a first taggant 20a and a second taggant 20b that is spaced-apart from the first taggant. Because the taggants 20a and 20b are hidden from view, they are represented by the dotted lines.

Referring now to FIG. 6, an overlay 28 provides a visual indicia that aids a user in determining whether the product is counterfeit or has been diverted. The overlay 28 includes a film sheet 30 and a grid 32 that is used to delineate areas on the label 24. In some embodiments, the film sheet 30 is formed of a transparent or translucent, plastic material. Identifiers 34 and 36 are associated with columns and rows of the grid 32, respectively. The identifiers 34 and 36 are used to uniquely identify each cell 38 of the grid 32.

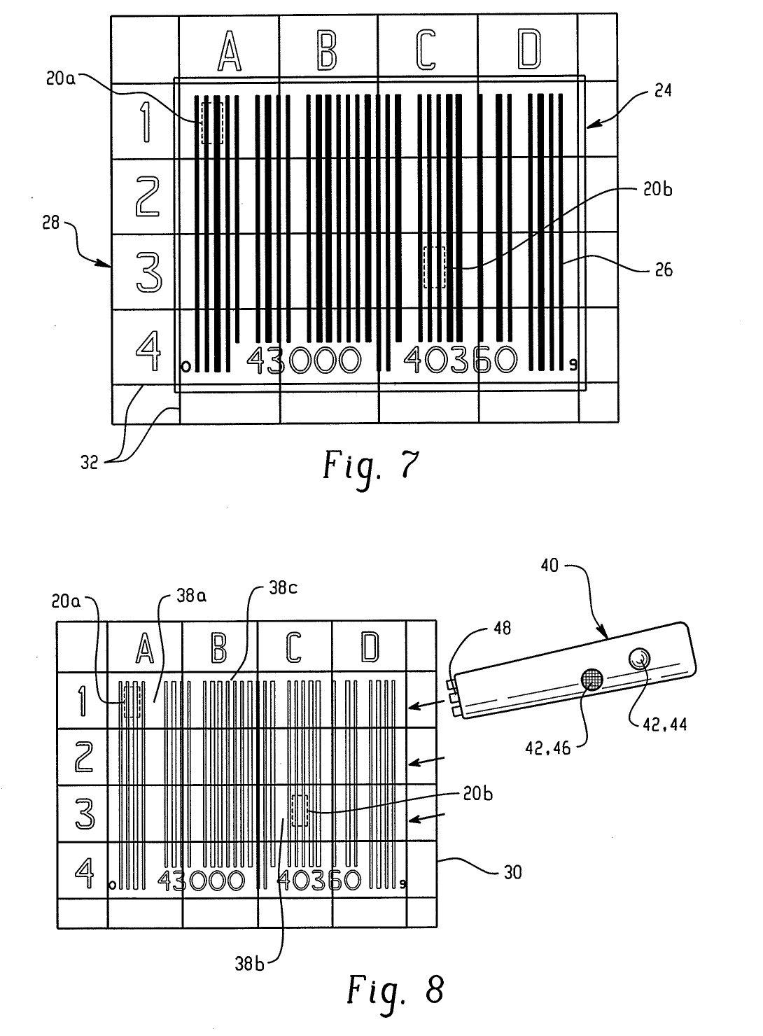

Referring to FIG. 7, the overlay 28 is shown placed over the label 24. In this embodiment, the barcode 26 can be used to center the overlay 28 on the label 24 by centering the barcode within the grid 32.

Other positioning methods can be used to properly locate the overlay 28 on the label 24. For example, the label 24 may include an alignment feature printed thereon such as a printed line, border and/or one or more printed dots. The overlay 28 may also include a corresponding printed line, border and/or one or more corresponding printed dots that can be aligned with those on the label 24 to properly align the overlay with the label. Corresponding raised features and/or cut-out features may also be used to align the overlay 28 and label 24.

Once the overlay 28 is positioned on the label 24, the overlay is used determine whether the product has been diverted and/or is counterfeit. Referring now to FIG. 8, a reader 40 is a detector that is used to detect presence (or absence) of the taggants 20a and 20b. A suitable reader is commercially available from Stardust Materials, L.L.C. In some embodiments, the reader 40 includes a radiation source capable of emitting radiation in the infrared wavelength range to excite the emitting taggant material and a sensor that detects radiation emitted by the emitting taggant material. The reader 40 and the taggants 20a and 20b may be arranged and configured such that the reader detects presence of the taggants only when the reader is at their associated cell 38a and 38b. For example, if the reader 40 is in cell 38c, adjacent cell 38a, no taggant is detected by the reader until the reader moves within cell 38a. In certain embodiments, the reader 40 includes an indicator 42, such as a light 44 and/or speaker 46 that provide an indication to the user that the taggant 20a, 20b is detected. The light 44 may illuminate and the speaker 46 may provide an audible sound when the taggant 20a, 20b is detected. Other indications are possible, such as vibration.

FIG. 8 illustrates an exemplary method for determining the authenticity of the product. The user manually places the overlay 28 on the label 24 and aligns the overlay with the barcode 26, as described above. The user then manually manipulates the activated reader 40 by bringing end 48 in contact with the film sheet 30 at the end of row 1 and the reader is moved along row 1 beginning at column D and moving through column A. In this sense, the grid 32 serves as a guide for the reader 40. The reader 40 emits infrared radiation as it moves thereby exciting the taggant 20a once the reader moves into cell 38a. The taggant 20a emits infrared radiation, which is detected by the reader 40 with the reader located in cell 38a and the reader provides an indication of presence of the taggant in response. The user can then use the identifiers 34 and 36 to identify the cell as A-1. This process is repeated with rows 2-4. With the reader in cell 38b, the user identifies cell D-4 as including taggant 20b. The user can then compare the identified cells A-1 and D-4 with known identifiers associated with the product or shipment. If there is a match, then the product or shipment is authenticated and not diverted (i.e., sent to the wrong location and/or at the wrong time). If there is not an exact match, but taggants are detected in one or more cells other than A-1 and D-4, then the product or shipment is likely authentic, but has been diverted. If no taggants are detected, then the shipment or product is likely counterfeit.

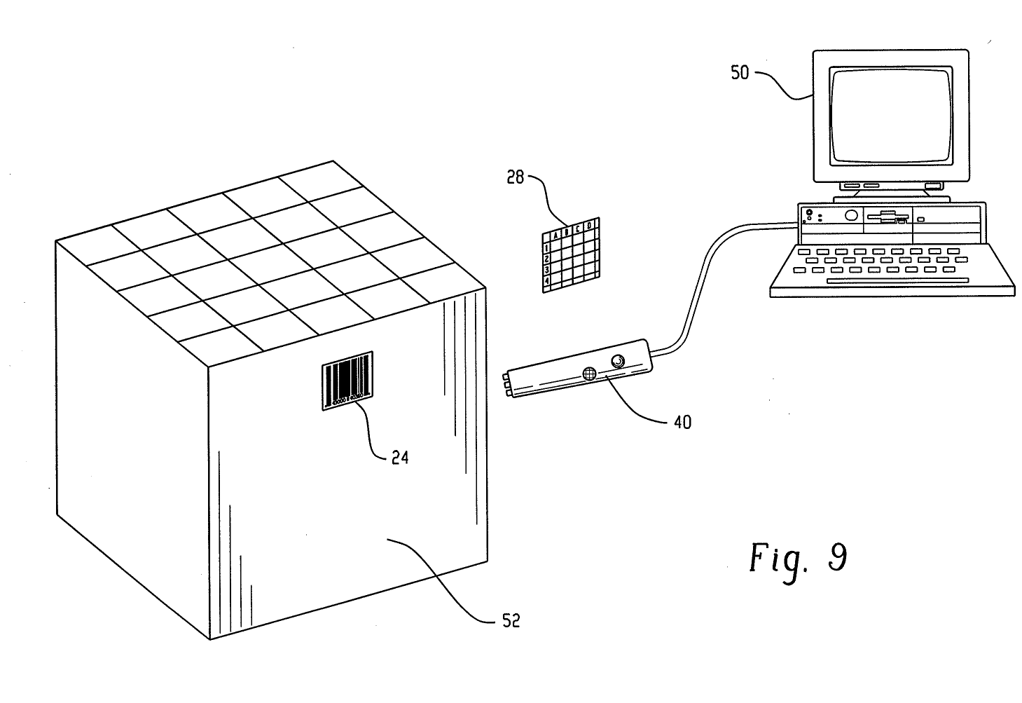

Referring to FIG. 9, the reader 40 may be connected to a computer 50 or other device such as a hand-held computer to determine whether a case 52 of product being moved, transported, received, etc. has been diverted or is counterfeit. For example, a predetermined identifier (e.g., A-1 and D-4) may be saved within memory of the computer 50 that is associated with an expected case of product. The reader 40 and overlay 28 are used to detect the presence (or absence) in label 24 located on the product case 52 (or on a product within the case). Identifiers are determined based on location of taggant(s) within the label 24 as described above and entered into the computer 50. The computer 50 can then determine automatically whether the case is authentic and has not been diverted.

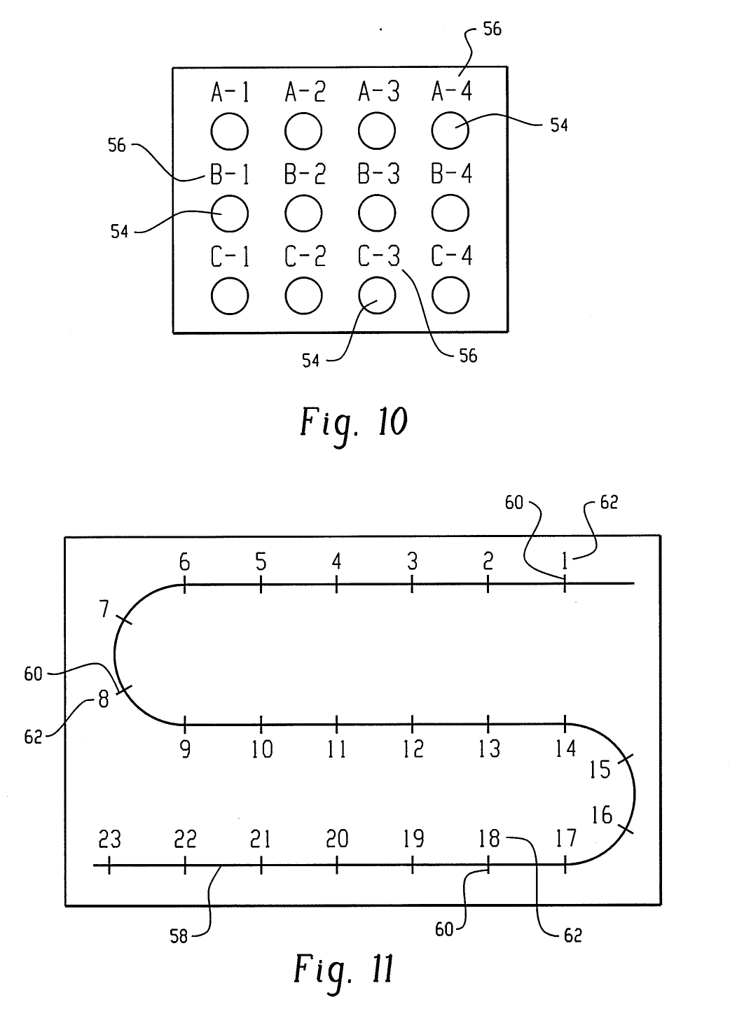

While overlay 28 is shown with a grid 32, any other suitable pattern may be used. Referring to FIG. 10, a series of circles 54 are shown, each including its own identifier 56. Referring to FIG. 11, a line 58 is shown including demarcations 60 each having an identifier 62 associated therewith. The user can move the end of the reader 40 along the line 58 until the taggant(s) are detected.

In some embodiments, the emitting taggant material may emit radiation in the visible wavelength range, for example, upon absorption of infrared radiation. In some instances, the visible light may be viewed through the label and serve as a visual indication of the taggant's presence. In certain embodiments, the color of the visible light may also be used in determining the authenticity of the product or shipment. In some embodiments, each taggant may emit radiation at different wavelengths. For example, within a label, one taggant may emit radiation at a first wavelength and a second taggant may emit radiation at a second, different wavelength. The reader may also be configured to differentiate between the two wavelengths and provide different indications to the user in response to those wavelengths. For example, the reader may emit a red light in response to detection of the first wavelength and a blue light in response to detection of the second wavelength.

It is to be clearly understood that the above description is intended by way of illustration and example only and is not intended to be taken by way of limitation, and that changes and modifications are possible. For example, the identifiers may not only be used to determine whether a product or shipment of product is authentic and not diverted, but also what type of product is included. For example, a first series of identifiers (e.g., A-1 through A-4) may be associated with different product types and a second series of identifiers (D-1 through D-4) may be associated with different destinations. Accordingly, other embodiments are contemplated and modifications and changes could be made without departing from the scope of this application as expressed by any claims now included or hereafter added.

What is claimed is:

1. A method for use in determining product counterfeiting and diversion, the method comprising:
locating an overlay on a label associated with a product, the label including indicia printed thereon, the overlay delineating areas of the label, each area having an identifier associated therewith; and
detecting presence of a taggant within one or more of the areas using a reader, the taggant being hidden from sight and providing an indication of its presence that is detectable by the reader.

2. The method of claim 1 further comprising determining the identifier associated with the one or more areas in which the taggant is detected.

3. The method of claim 2 further comprising comparing the identifier associated with the one or more areas in which the taggant is detected with one or more known identifiers to determine product counterfeiting or diversion.

4. The method of claim 2, wherein the identifiers associated with the areas are part of the overlay.

5. The method of claim 1, wherein the taggant is located under the indicia.

6. The method of claim 1, wherein the taggant comprises an emitting taggant material that emits visible and/or infrared radiation upon exposure to infrared radiation.

7. The method of claim 6 further comprising exposing the emitting taggant material to infrared radiation using the reader and detecting the radiation emitted by the emitting taggant material using the reader.

8. The method of claim 7 further comprising the reader providing an indication to a user upon detecting the radiation emitted by the emitting taggant material.

9. The method of claim 8, wherein the indication provided by the reader to the user is a visual indication and/or an audible indication.

10. The method of claim 1 further comprising positioning the reader manually on the overlay.

11. The method of claim 10, wherein the overlay comprises a film and a grid printed on the film, the grid delineating the areas, the film being separate from the product label.

12. The method of claim 11 further comprising reusing the film by locating the overlay on a second label.

13. The method of claim 11, wherein the identifiers associated with the delineated areas are printed on the film.

14. The method of claim 11, wherein the film is transparent or translucent such that the label is visible therethrough.

15. The method of claim 1, wherein the label is affixed to a product container or a product case.

16. A system for use in determining product counterfeiting and diversion, the system comprising:
a label including a taggant located within a discrete region of the label;
an overlay including visual indicia that delineates areas of the label with the overlay placed thereon, each area having an identifier associated therewith; and
a reader for detecting presence of the taggant within a delineated area of the label.

17. The system of claim 16, wherein the overlay comprises a plastic film with the visual indicia printed on the plastic film.

18. The system of claim 17, wherein the plastic film is transparent or translucent.

19. The system of claim 17, wherein the overlay includes the identifier printed thereon.

20. The system of claim 17, wherein the visual indicia is in the form of a grid.

21. The system of claim 16, wherein the taggant comprises an emitting taggant material.

22. The system of claim 21, wherein the reader comprises an infrared radiation source for providing infrared radiation to the emitting taggant material.

23. The system of claim 16, wherein the taggant comprises metal and the reader is a magnetic reader.

24. The system of claim 16, wherein the label includes a first taggant comprising the emitting taggant material and a second taggant comprising an emitting taggant material spaced from the first taggant, the first and second taggants emitting radiation in response to absorption of infrared radiation, wherein the first taggant emits radiation at a first wavelength in response to absorption of infrared radiation and the second taggant emits radiation at a second wavelength that is different than the first wavelength in response to absorption of radiation.

25. The system of claim 24, wherein the reader is configured to provide a first indication to a user upon detection of the first wavelength and to provide a second indication to the user upon detection of the second wavelength, the first indication being different than the second indication.
